(19) United States
(12) Patent Application Publication
(10) Pub. No.: US 2023/0263704 A1
(43) Pub. Date: Aug. 24, 2023

(54) HEAT STORAGE SAUNA HEATER AND SAUNA CABIN

(71) Applicant: THESS UG haftungsbeschränkt, Dresden (DE)

(72) Inventor: André THESS, Dresden (DE)

(73) Assignee: THESS UG haftungsbeschränkt, Dresden (DE)

(21) Appl. No.: 18/167,678

(22) Filed: Feb. 10, 2023

(30) Foreign Application Priority Data
Feb. 22, 2022 (EP) 22157979.0

(51) Int. Cl. A61H 33/06; F28D 20/00; A61H 33/00

(52) U.S. Cl. CPC A61H 33/063; F28D 20/0034; A61H 33/005; A61H 2201/5097

(57) ABSTRACT

The subject of the present invention is a sauna storage heater and a sauna cabin which uses the sauna storage heater. The sauna heater can be operated independently in terms of energy without a connection to the power grid and without the use of fuels such as wood, gas, or oil. A heat storage fluid is used in the sauna storage heater, the boiling temperature of which fluid is over 100° C. at normal pressure. The heat output from the sauna storage heater is regulated by means of flaps on air inlet and air outlet openings.

### CROSS-REFERENCE TO RELATED APPLICATIONS

This application claims priority to European Application No. EP 22 157 979.0, filed on Feb. 22, 2022, the entire contents of which are hereby incorporated by reference herein.

### FIELD OF THE INVENTION

The subject of the present invention is a heater for a sauna cabin (sauna storage heater, thermal storage sauna heater) which can be operated independently in terms of energy without being connected to the power grid, and without the use of fuels such as wood, gas, or oil. Furthermore, a sauna cabin is described which uses the heater according to the invention.

### BACKGROUND OF THE INVENTION

There are various approaches which propose a sauna heater that can be operated by means of renewable energies.

One obvious solution envisions the use of photovoltaic systems in combination with batteries, wherein the batteries supply the current for operating an electric heater for the sauna heater. However, this approach is time-consuming, complex, and expensive.

Furthermore, solutions are known which propose the use of solar cells for generating the energy for sauna cabins. By way of example, DE 10 2013 990 A1 is cited, which proposes such a solution for a secondary task, but does not disclose a detailed procedure.

JP 5 731 926 B2 proposes charging a water tank for a sauna by using solar thermal energy, co-generation, or off-peak electricity. In addition to a heating function, the water tank should also have one or more nozzles for dispensing steam.

DE 10 2018 003 136 A1 describes a sauna storage heater based upon a pressurized water tank which is loaded by a solar thermal collector. A disadvantage of this solution is the use of a pressure tank (pressurized water tank). Such pressure tanks pose a potential hazard if not properly maintained.

DE 20 2016105 688 U1 describes a sauna heater which uses a phase change material as an energy store. In an evaporation channel which is arranged within the sauna heater and has an inlet and outlet channel, a liquid to be evaporated is to enter and leave as steam.

In KR 20 160 060 940 A, a therapeutic sauna is described which has a device for nebulizing medicines.

In particular, for areas where there are no reliable power grids, maintenance professionals, or technical monitoring organizations, the state of the art solutions are not suitable.

The task therefore exists of proposing a sauna heater that combines a simple design, low maintenance, reliability, and manageable cost. The sauna storage heater should still heat the air in the sauna room to temperatures up to 100° C. if necessary. The thermal storage sauna heater is suitable for external temperatures between −40° C. and +50° C. Furthermore, a suitable sauna cabin construction is proposed. The terms, sauna and sauna cabin, are used synonymously below.

### SUMMARY OF THE INVENTION

According to the invention, the object is achieved with a sauna storage heater as described and claimed herein. The advantageous use of such a sauna heater is also described and claimed herein.

### BRIEF DESCRIPTION OF THE DRAWINGS

FIG. 1 schematically shows the thermal storage heater 1 according to the invention in a vertical sectional view.

FIG. 2 schematically shows the layout of a cylindrical thermal storage heater 1 in a horizontal sectional view.

FIG. 3 schematically shows the sauna cabin according to the invention in a vertical sectional view.

FIG. 4 schematically shows the sauna cabin according to the invention in a horizontal sectional view.

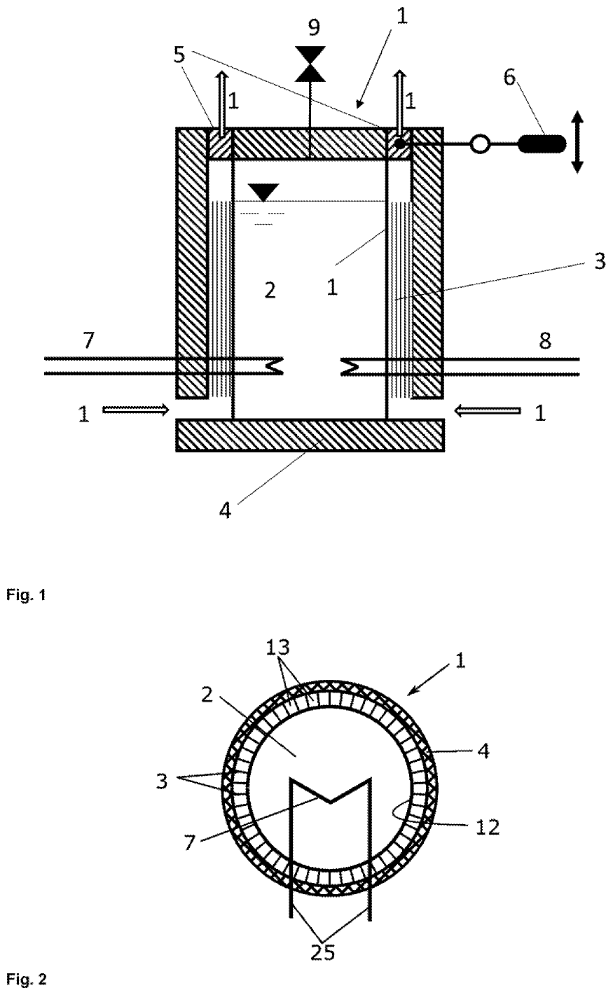

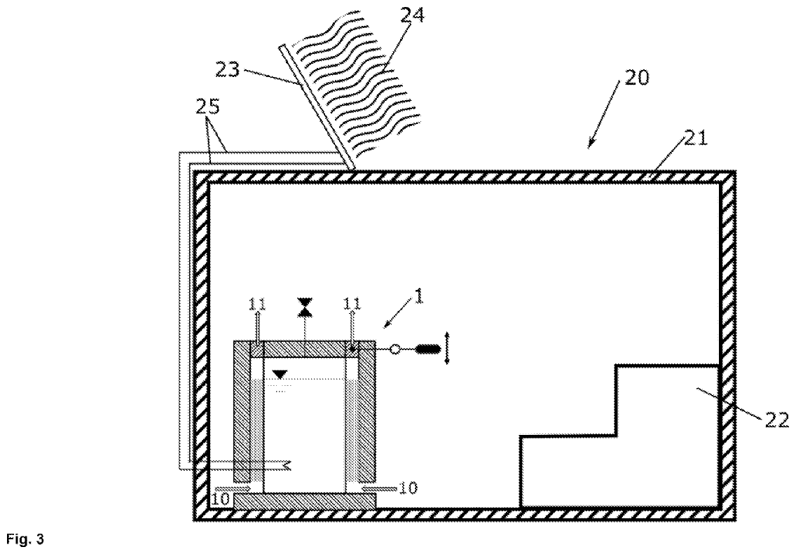

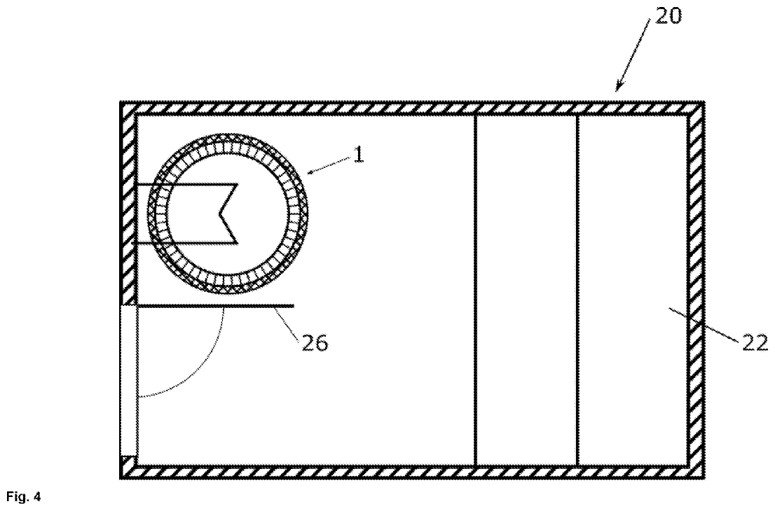

### DETAILED DESCRIPTION OF THE INVENTION

The sauna storage heater according to the invention has a thermal storage tank. The thermal storage tank contains a heat storage fluid. The heat storage fluid has a boiling point at normal pressure which is over 100° C., preferably over 105° C., and most preferably over 120° C. The thermal storage tank has heat transfer fins on parts of the outside of its wall which do not serve as a standing surface. Preferably, no heat transfer fins are provided on the top surface of the thermal storage tank. The heat transfer fins are preferably oriented vertically. A thermal insulation layer is arranged around the thermal storage tank and, by means of the heat transfer fins, spaced apart from the wall of the thermal storage tank. The standing surface and the top surface of the thermal storage tank are optionally covered completely or partially by a thermal insulation layer.

The thermal storage tank is preferably made of stainless steel, steel with an anti-corrosion coating, aluminum, or other materials that have the necessary stability and effective thermal conductivity. In one embodiment, the lateral surface of the thermal storage tank consists of a very effective heat-conducting material, e.g., aluminum, while the standing surface (base surface) and the top surface are made of less effective heat-conducting material. This serves to reduce heat losses.

In a simple embodiment, the thermal storage tank is produced from stainless steel plates welded together. The heat transfer fins are welded to the outer wall (lateral surface) in the form of vertically-extending stainless steel strips.

The thermal storage tank and therefore also the entire sauna storage heater preferably have a cuboid shape (preferably a cube shape). Also preferred is a cylindrical shape. Optionally, however, other shapes are also suitable—for example, that of a truncated pyramid or cone. The sauna storage heater can therefore advantageously be adapted to the available installation space. The sauna storage heater stands preferably directly on the base surface. Optionally, stand feet or a stand frame are provided.

The heat storage fluid in the thermal storage tank is, for example, propylene glycol, a mixture of propylene glycol and water, or salt water. When using salt water or similar heat storage fluids that are corrosive to the material of the thermal storage tank or its fittings, the thermal storage tank or its fittings (heat exchanger, heating element) are provided with a suitably stable coating.

The thermal insulation layer (thermal insulation) consists of thermal insulation material according to the prior art. For example, glass fiber, glass wool, temperature-resistant plastic, mineral wool, high-temperature polyurethane foam, or similar thermal insulation materials also used in the construction industry are suitable and have the required thermal resistance.

For safety reasons, the thermal storage tank has an overpressure valve that prevents the buildup of an unacceptable internal pressure in the thermal storage tank. The overpressure valve is preferably arranged on the top side (top surface) of the thermal storage tank.

In the region of the ends of the heat transfer fins close to the ground, one or more air inlet openings are provided in the thermal insulation layer. One or more air outlet openings in the thermal insulation layer are provided in the region of the upper ends of the heat transfer fins. Air inlet and air outlet openings are connected by channels, which are formed by the wall of the thermal storage tank, the thermal insulation, and the heat transfer fins.

Air circulation is therefore possible, wherein the cool air flow enters through the air inlet openings into the intermediate space between the wall of the thermal storage tank and the thermal insulation layer, is heated at the wall of the thermal storage tank and the heat transfer fins, and leaves the intermediate space in a heated state at the air outlet openings. The guidance of the air flow in the intermediate space results in an advantageous chimney effect, which supports the heat discharge from the thermal storage tank.

In one embodiment, the thermal insulation layer is modular in design and is configured to be removable. This advantageously allows the thermal insulation layer to be removed from the thermal storage tank, and the channels of the sauna storage heater to be cleaned.

To control the heat discharge from the thermal storage tank, closures for the air outlet openings and, optionally, also the air inlet openings are provided.

Preferably, known flaps or lamella closures are used as closures. The closures of the air outlet or, optionally, also of the air inlet openings can in turn be equipped with thermal insulation. Furthermore, it is possible to arrange these closures two or more times in succession in the direction of air flow, so that an air flow which would deliver heat to the outer closure is slowed down or stopped by further closures arranged upstream.

Preferably, the closures are actuated purely mechanically. This makes it possible to dispense with auxiliary energy. If auxiliary energy is available, an electromechanical, electronic, or other type of actuation is of course also possible, including temperature-dependent regulation of the closure position.

The heat input into the thermal storage tank is preferably by means of solar thermal loading. For this purpose, at least one solar thermal collector (solar collector) is provided which has a heat transfer medium circulating in a loading circuit. The heat transfer medium absorbs heat in the solar thermal collector and discharges it to the heat storage fluid of the thermal storage tank via a heat exchanger arranged inside the thermal storage tank. Of course, several solar collectors, loading circuits, and heat exchangers can be provided.

The circulation of the heat transfer medium in the loading circuit is either pump-driven (if auxiliary energy is available), or, preferably, due to the thermal circulation that forms.

In one embodiment, the pipes of the loading circuit are able to be shut off individually or together close to their exit from the thermal insulation layer of the thermal storage tank, in order to prevent undesired discharge circulation in the circuit or single pipe circulation during the night hours. Optionally, a Z-shaped siphon is also provided per pipeline for suppressing single pipe circulation.

Another option, which can be used either as an alternative to or together with solar thermal loading, is loading by photovoltaically-generated energy. In the interior of the thermal storage tank, one or more electric heating elements (resistance heaters) are then provided alternatively to or in combination with the heat exchanger. The energy is generated by means of one or more photovoltaic collectors.

Preferably, the heat exchanger for discharging the heat to the heat storage fluid is arranged in the thermal storage tank in the lower third of the thermal storage tank. This also applies to a possibly present heating element for photovoltaic loading of the thermal storage tank.

In one embodiment, the photovoltaically-generated energy serves only as auxiliary energy and not, or only partially, for the thermal loading of the thermal storage tank. For this purpose, the photovoltaically-generated energy can optionally be temporarily stored in a battery. For example, a circulating pump for the heat transfer medium of the solar thermal circuit for loading the thermal storage tank can be fed from the auxiliary energy generated. Furthermore, the drive or the control of the closures for the air outlet openings, and, optionally, also the air inlet openings as well as the illumination of the sauna cabin, can also be operated with the auxiliary energy.

The use of propylene glycol or a mixture of 90% propylene glycol and 10% water eliminates the need for a pressure tank, and a pressure-less thermal storage tank can advantageously be used. Propylene glycol is harmless to health, is used as a de-icing agent in aviation, and does not cause contamination of the floors upon leaking.

The thermal storage sauna heater according to the invention advantageously combines thermal storage and a radiator in one device. This makes it possible to dispense with a separate radiator for the transfer of the heat into the sauna room. By attaching heat transfer fins to the outer wall of the thermal storage tank, a compact design and a small space requirement are, advantageously, possible.

The heat output is advantageously designed to be switchable. The heat transfer from the sauna heater to the sauna room, which is preferably switchable by a lever, by means of a manually- or electronically-actuated flap or lamella system enables a more robust construction than in the prior art, and eliminates the need for circulating pumps and the like.

It is also within the scope of the invention to optionally monitor the loading state of the thermal storage sauna heater by means of thermal sensors, transmit it to the user via mobile radio or via the Internet, and display it by means of an app. The app can optionally also be used for remote control of the storage heater.

The sauna cabin according to the invention uses the above-described thermal storage sauna heater (sauna heater). In embodiments, the sauna cabin is designed as a Finnish sauna. By additionally installing an infusion stove, infusion typical in Finnish saunas can be realized. However, it is also within the scope of the present invention to design the sauna cabin as a Hammam or steam sauna, by operating the thermal storage sauna heater at lower temperatures and generating high humidity by additionally installing a steam generator.

In a first embodiment, the sauna heater is arranged in a sauna cabin which is provided for, nominally, four people. As a result of the compact dimensions of the sauna heater and the space-saving arrangement of the two benches, it is possible to greatly reduce the outer dimensions of the sauna cabin. This enables easy transport and use even in more remote areas. The dimensions of the sauna cabin are preferably selected so that the entire sauna cabin can be transported in standard containers. The sauna cabin preferably has a stiff support frame, which holds the sauna walls, the ceiling, and the floor. The support frame can be manufactured, for example, from double-T beams of steel. Optionally, the support frame has attachment points for crane hooks or threads for screwing in attachment eyes for crane hooks. This advantageously makes it possible to easily transfer or more easily relocate the sauna cabin.

The one or more solar thermal and/or photovoltaic collectors are preferably arranged on the roof of the sauna cabin. Of course, an additional or alternative arrangement of solar thermal and/or photovoltaic collectors next to the sauna or on their own auxiliary stand is also possible. The dimensions of the solar collectors or solar cells, as well as the pipelines for the heat transfer medium, are preferably selected so that the components can be stored in the sauna cabin during transport. Preferably, the container is also accommodated, with the heat transfer medium, in the sauna cabin during transport. In this way, it is, advantageously, possible to provide prefabricated sauna cabins with all the materials needed for installation and operation.

In one embodiment, the sauna cabin has a display on its exterior that signals whether the sauna storage heater is sufficiently loaded with heat energy and/or whether the sauna cabin is currently in use. For example, one or more rows of light-emitting diodes on the outer edges of the sauna cabin can be suitable for this purpose, which shine or flash in different colors (e.g., heat accumulator loaded—red, heat accumulator unloaded—blue, optionally also with the respective color portion in the row of light-emitting diodes as a function of the degree of loading of the sauna storage heater). Optionally, this display is operated by auxiliary power, which is also used for controlling the closure position or operating the circulation pump.

In further embodiments, several sauna storage heaters are arranged in a sauna cabin for larger groups of persons. Scaling the use of the sauna storage heater according to the invention is also possible by adjusting the size of the employed sauna storage heaters, as an alternative or in addition to varying the number of employed sauna storage heaters. Since larger sauna cabins also usually require a larger roof area, the arrangement of additional and/or larger solar thermal collectors on the roof is possible.

The invention is not limited to the illustrated and described embodiments, but also includes all embodiments which act identically within the meaning of the invention. Furthermore, the invention is also not limited to the specifically described feature combinations, but may also be defined by any other combination of particular features of all individual features disclosed overall, provided the individual features are not mutually exclusive, or a specific combination of individual features is not explicitly excluded.

### Exemplary Embodiments

The invention will be explained in greater detail below with reference to an exemplary embodiment and the drawings.

For the following exemplary embodiment, a small sauna 20 with thermal storage heaters 1 for four persons with a heating demand of approximately 4 kW and a thermal energy storage capacity between 10 kWh and 20 kWh for a sauna evening (corresponding to approximately 3-5 hours of use) is used.

The thermal storage tank 12 for the heat storage fluid 2 is of cylindrical design, has a height of 1 m, a diameter of 0.6 m, and is made of stainless steel sheet without pressure. It therefore has a capacity of more than 300 liters. The side surface is just under 2 m².

Fifty sheets of aluminum with a material thickness of 2 mm are attached as heat transfer fins 3, spaced at intervals of about four centimeters from each other on the outer wall of the thermal storage tank 12. Each sheet is 1 m long and 0.1 m wide. The total heat transfer surface is therefore more than 10 m² and, in the case of an average temperature drop of 20 K between the incoming cold air flow 10 to be heated and the heat storage fluid 2, ensures the above-mentioned heat flow of 4 kW in the hot air flow 11.

The thermal storage tank 12 is protected from the outside by a commercially available thermal insulation jacket 4 (mineral wool) of 0.1 m thickness. With an effective thermal conductivity of the thermal insulation material 4 of 0.1 W/mK, a maximum temperature difference of 100 K between the hot heat storage fluid 2 (120° C.) and the cold sauna interior air (20° C.), and an outer surface of the thermal insulation material 4 of 3 m², in the worst case of a fully thermally loaded thermal storage sauna heater 1, a heat loss flow of 300 W results, which is sufficiently small for the necessary insulation task.

By manual actuation of a flap mechanism 5, 6, which is attached to the upper (and, if necessary, additionally to the lower) edge of the thermal storage sauna heater 1, the vertical flow channels 13 between the heat transfer fins 3 open and allow the air to be heated. It is of course also within the scope of the invention to actuate the mechanism electronically.

The heat storage fluid 2 can be heated (loaded with thermal energy) either by means of an electric heating coil 8 coupled to the photovoltaic system in the lower part of the thermal storage tank 12, or by means of a heat exchanger 7 for the solar-heated heat transfer fluid from the solar thermal system (solar collector 23 and piping 25). It is of course also within the scope of the invention to combine both forms of heating with one another and to heat the thermal storage device 1 in a hybrid fashion. In the absence of direct solar irradiation (where the solar thermal system provides little heat), the photovoltaic system (not shown) could therefore provide at least some heat. When there is a large amount of direct solar radiation 24, however, the solar thermal system 23, 25 would supply the majority of the heat. The advantages of the two heating technologies (photovoltaic yield even in hazy weather, solar thermal—very efficient with direct irradiation) could therefore be combined.

For solar thermal loading of the thermal storage furnace 1 over one day, an area of 5 m² is to be provided for the solar collectors.

The sauna heater 1 is arranged in a sauna cabin 20 which is provided for, nominally, four people. The sauna cabin 20 is entered through the door 26. Due to the compact dimensions of the sauna heater 1 and the space-saving arrangement of the two sauna benches 22, it is possible to reduce the external dimensions of the sauna cabin 1 enough that two sauna cabins 1 fit into a standard international 20-foot container. This requires outer maximum dimensions (W×L×H) of 2.35×2.80×2.30 m for the sauna cabin 1. The sauna cabin 1 has a cuboid steel frame made of double-T beams running along the outer edges of the sauna cabin 1. The sauna cabin 1 is covered on the inner and outer sides with surface-treated wooden boards. In the wall 21, a thermal insulation 10 cm thick of mineral wool is provided between the inner and outer sides. At the upper corners of the sauna cabin 1, the steel frame is exposed and has a threaded opening at each corner for eyelets for attaching crane ropes (not shown).

### REFERENCE SIGNS

1 Thermal storage heater (entire)
2 Heat storage fluid
3 Heat transfer structures
4 Thermal insulation
5 Flap system
6 Flap actuation device
7 Thermal heat supply element
8 Electric heat supply element
9 Safety valve
10 Cold air flow
11 Hot air flow
12 Thermal storage tank
13 Channels of the air flow
20 Sauna cabin
21 Wall of the sauna cabin
22 Sauna bench
23 Solar collector
24 Incident solar radiation
25 Pipelines of the solar thermal circuit
26 Door of the sauna cabin

1. A sauna heater having a thermal storage tank with a heat storage fluid, wherein:
the boiling temperature of the heat storage fluid at normal pressure is over 100° C.,
at least one heat exchanger and/or at least one heating element is arranged in the lower third of the thermal storage tank,
the thermal storage tank has heat transfer fins at least on parts of the outer side of its wall,
a thermal insulation layer is arranged around the thermal storage tank and, because of the heat transfer fins, is spaced apart from the wall of the thermal storage tank,
at least one air outlet opening in the thermal insulation layer is provided in the region of the upper ends of the heat transfer fins,
at least one air inlet opening in the thermal insulation layer is provided in the region of the lower ends of the heat transfer fins, wherein the air inlet and air outlet openings are connected by channels, which are formed by the wall of the thermal storage tank, the thermal insulation, and the heat transfer fins.

2. The sauna heater according to claim 1, wherein the air outlet openings and, optionally, also the air inlet openings are designed to be closable.

3. The sauna heater according to claim 1, wherein the closing of the air outlet or air inlet openings is manually or electrically driven.

4. The sauna heater according to claim 2, wherein the closures of the air outlet or air inlet openings are arranged two or more times in succession in the direction of air flow, and/or the closures of the air outlet or air inlet openings are provided with thermal insulation.

5. The sauna heater according to claim 1, wherein the thermal storage tank has a cuboid shape, a cylindrical shape, or the shape of a truncated pyramid or cone, and/or the thermal storage tank has an overpressure valve.

6. The sauna heater according to claim 1, wherein the standing surface and the top surface of the thermal storage tank are completely or partially covered by a thermal insulation layer.

7. The sauna heater according to claim 1, wherein the thermal insulation layer is designed to be removable.

8. The sauna heater according to claim 1, wherein the heat exchanger loads the thermal storage tank with thermal energy through a solar thermal circuit, and/or the heating element loads the thermal storage tank with thermal energy by a photovoltaically-fed electric circuit.

9. The sauna heater according to claim 1, wherein the heat transfer medium is propylene glycol, a mixture of propylene glycol with water, or salt water.

10. The sauna heater according to claim 1, wherein the sauna heater has at least one battery and associated control electronics in order to enable photovoltaic charging of the at least one battery.

11. The sauna heater according to claim 10, wherein the sauna heater further has a transmitting and receiving module for wireless control of the sauna heater and the air inlet and outlet openings.

12. The sauna heater according to claim 10, wherein a circulation pump for circulating the heat transfer medium of the solar thermal circuit is driven by electrical energy of the batteries.

13. A sauna cabin comprising a sauna heater according to claim 1, wherein the one or more solar thermal and/or photovoltaic collectors are arranged on the roof of the sauna cabin.

14. The sauna cabin according to claim 13, wherein the sauna cabin has a display on its exterior that signals whether the sauna storage heater is sufficiently loaded with heat energy and/or whether the sauna cabin is currently in use.

15. A method of heating a sauna cabin comprising running the sauna heater according to claim 1.

16. The sauna heater according to claim 1, wherein the boiling temperature of the heat storage fluid at normal pressure is over 105° C.

17. The sauna heater according to claim 1, wherein the boiling temperature of the heat storage fluid at normal pressure is over 120° C.

18. The sauna heater according to claim 2, wherein the closing of the air outlet or air inlet openings is manually or electrically driven.

19. The sauna heater according to claim 1, wherein:
the boiling temperature of the heat storage fluid at normal pressure is over 120° C.;
the air outlet openings are closable;
the closures of the air outlet or air inlet openings are arranged two or more times in succession in the direction of air flow, and/or the closures of the air outlet or air inlet openings are provided with thermal insulation;
the standing surface and the top surface of the thermal storage tank are completely or partially covered by a thermal insulation layer; and
the heat exchanger loads the thermal storage tank with thermal energy through a solar thermal circuit, and/or the heating element loads the thermal storage tank with thermal energy by a photovoltaically-fed electric circuit.

20. The sauna heater according to claim 19, wherein the heat transfer medium comprises propylene glycol.
